(19) United States
(12) Patent Application Publication
(10) Pub. No.: US 2026/0177787 A1
(43) Pub. Date: Jun. 25, 2026

(54) Metal light collecting component, and optical imaging lens module including the metal light collecting component

(71) Applicant: Genius Electronic Optical (Xiamen) Co., Ltd., Xiamen (CN)

(72) Inventors: Weisen Cai, Xiamen (CN); Ziping LI, Xiamen (CN); Haibin Zhan, Xiamen (CN)

(73) Assignee: Genius Electronic Optical (Xiamen) Co., Ltd., Xiamen (CN)

(21) Appl. No.: 19/051,201

(22) Filed: Feb. 12, 2025

(30) Foreign Application Priority Data
Dec. 23, 2024 (CN) 202411906824.5

(51) Int. Cl. G02B 13/00; G02B 7/02

(52) U.S. Cl. CPC G02B 13/0055; G02B 7/02

(57) ABSTRACT

The invention provides a metal light collecting component and an optical imaging lens module comprising the metal light collecting component, wherein the metal light collecting component comprises a metal sheet and a light shielding sheet with an opening, and the light shielding sheet is arranged on a surface of the metal sheet, wherein a light collecting space is defined, wherein the light collecting space is located a region near the opening of the light shielding sheet, and located in a gap between the metal sheet and the light shielding sheet. The light collecting space has the effect of attenuating stray light entering the light collecting space through the opening.

### BACKGROUND OF THE INVENTION

### 1. Field of the Invention

The invention relates to the field of optics, in particular to a metal light collecting component and an optical imaging lens module comprising the metal light collecting component. The invention has the effects of reducing stray light and improving imaging quality.

### 2. Description of the Prior Art

The specifications of portable electronic products are changing with each passing day, and its key component-optical imaging lens is also developing more diversified. The application is not limited to shooting images and videos, but also meets the needs of telescopic camera shooting. However, the magnification of telescopic magnification is proportional to the focal length, so the lens size increases with the magnification. In order to improve the magnification while still maintaining the lens size, the existing high-magnification telescopic optical imaging lens mainly increases the light path in a limited space by light reflecting elements such as prisms, so as to achieve the purpose of increasing the focal length and telescopic magnification without increasing the lens size. However, if the optical imaging lens is designed with prism to increase the focal length, it will easily produce high-brightness stray light, such as torch stray light, which will affect the imaging quality.

### SUMMARY OF THE INVENTION

The invention provides a metal light collecting component, which comprises a metal sheet, and a light shielding sheet with an opening arranged on a surface of the metal sheet, wherein a light collecting space is defined, wherein the light collecting space is located in a region near the opening of the light shielding sheet, and located in a gap between the metal sheet and the light shielding sheet, wherein the light collecting space has the effect of attenuating stray light entering the light collecting space through the opening.

The invention also provides an optical lens imaging module, which comprises a barrel, an optical imaging lens arranged in the barrel, a light reflecting element arranged in the barrel, and the light reflecting element comprises a first reflecting surface, a second reflecting surface, a third reflecting surface and a fourth reflecting surface, a metal light collecting component arranged on an outer surface of one of the first reflecting surface, the second reflecting surface, the third reflecting surface and the fourth reflecting surface, wherein the metal light collecting component comprises a metal sheet, and a light shielding sheet with an opening arranged on a surface of the metal sheet, wherein a light collecting space is defined, wherein the light collecting space is located in a region near the opening of the light shielding sheet, and located in a gap between the metal sheet and the light shielding sheet, wherein the light collecting space has the effect of attenuating stray light entering the light collecting space through the opening.

In some embodiments of the present invention, the surface of the metal sheet has a first black film.

In some embodiments of the present invention, the metal light collecting component further comprises a first pressure sensitive adhesive disposed between the metal sheet and the light shielding sheet, wherein A is defined as an area of the light shielding sheet, B is defined as an area of the first pressure sensitive adhesive, and C is defined as an area of the opening, and the condition of A>B+C is satisfied.

In some embodiments of the present invention, the condition of A−(B+C)>4.40 mm² is satisfied.

In some embodiments present invention, the condition of 3.20≤DPSmin/Tpsa1≤12.00 is satisfied, wherein DPSmin is a shortest distance from the opening to the first pressure sensitive adhesive, and Tpsa1 is a thickness of the first pressure sensitive adhesive.

In some embodiments of the present invention, the conditions of 0.15 mm≤DPSmin≤0.40 mm and 0.03 mm≤Tpsa1≤0.05 mm are satisfied, wherein DPSmin is a shortest distance from the opening to the first pressure sensitive adhesive, and Tpsa1 is a thickness of the first pressure sensitive adhesive.

In some embodiments of the present invention, an area where the light shielding sheet that is not adhered to the first pressure sensitive adhesive is defined as D, and the condition of D>C is satisfied.

In some embodiments of the present invention, the metal sheet comprises an etched area, and an area of the etched area is defined as E, and the condition of E>B is satisfied.

In some embodiments of the present invention, the condition of 0.07 mm≤Tmp+Tpsa1+Tsoma≤0.10 mm is satisfied, Tmp is defined as a thickness of the area where the metal sheet contacts the first pressure sensitive adhesive, Tpsa1 is a thickness of the first pressure sensitive adhesive, and Tsoma is a thickness of the light shielding sheet.

In some embodiments of the present invention, further comprising a second pressure sensitive adhesive disposed on the metal sheet, and satisfying the condition of 0.93≤(Tm+Tpsa2)/(Tmp+Tpsa1+Tsoma)≤1.05, wherein Tpsa2 is a thickness of the second pressure sensitive adhesive, Tm is a maximum thickness of the metal sheet, Tmp is defined as a thickness of the area where the metal sheet contacts the first pressure sensitive adhesive, Tpsa1 is a thickness of the first pressure sensitive adhesive, and Tsoma is a thickness of the light shielding sheet.

In some embodiments of the present invention, the second pressure sensitive adhesive is designed in a U shape and surrounds the light shielding sheet.

In some embodiments of the present invention, the metal light collecting component is arranged on an outer surface of the third reflecting surface of the light reflecting element.

In some embodiments of the present invention, the light reflecting element has a light-transmitting region and a non-light-transmitting region, the surface of the light-transmitting region has a microstructure anti-reflection film, and the surface of the non-light-transmitting region has a second black film, and the metal light collecting component is adhered to the non-light-transmitting region by a second pressure sensitive adhesive, and the light shielding sheet is arranged on the light-transmitting region.

In some embodiments of the present invention, wherein X is defined as a thickness of the second black film, Y is defined as a thickness of the microstructure anti-reflection film, and the condition of X>Y is satisfied.

The present invention is characterized in that in order to solve the problem that light reflecting elements (such as prisms) in an optical imaging lens module are easy to generate stray light, a metal light collecting component that can be adhered to the surface of the prism and an optical imaging lens module including the metal light collecting component are provided.

Compared with the embodiment without metal light collecting components or the embodiment with only one layer of light shielding sheet, the embodiments of the invention can effectively reduce stray light and improve imaging quality. In addition, the metal light collecting component of the invention can be manufactured separately from the prism and has a relatively firm structure, and compared with the embodiment of directly forming an anti-reflection layer on the surface of the prism, the structure of the present invention has the advantages of simple assembly, high yield, stable structure and the like.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing the three-dimensional structure of an optical imaging lens module of the present invention.

FIG. 2 is a schematic sectional view of an optical imaging lens module according to the present invention.

FIG. 3 is a schematic diagram showing the three-dimensional structure of an optical imaging lens module of the present invention viewed from a bottom surface direction.

FIG. 4 shows a simulation diagram of imaging ray passing through an optical imaging lens and a light reflecting element.

FIG. 5 shows a simulation diagram of imaging ray passing through an optical imaging lens and a light reflecting element in another embodiment of the present invention.

FIG. 6 shows a front perspective view and a back perspective view of the metal light collecting component.

FIG. 7 shows a top view of a metal light collecting component according to an embodiment of the present invention.

FIG. 8 shows a sectional view taken along the section line A-A′ of FIG. 7.

FIG. 9 shows a top view of a metal light collecting component according to another embodiment of the present invention.

FIG. 10 shows a sectional view taken along the section line B-B′ of FIG. 9.

### DETAILED DESCRIPTION

To provide a better understanding of the present invention to users skilled in the technology of the present invention, preferred embodiments are detailed as follows. The preferred embodiments of the present invention are illustrated in the accompanying drawings with numbered elements to clarify the contents and the effects to be achieved.

Please note that the figures are only for illustration and the figures may not be to scale. The scale may be further modified according to different design considerations. When referring to the words “up” or “down” that describe the relationship between components in the text, it is well known in the art and should be clearly understood that these words refer to relative positions that can be inverted to obtain a similar structure, and these structures should therefore not be precluded from the scope of the claims in the present invention.

### First Embodiment

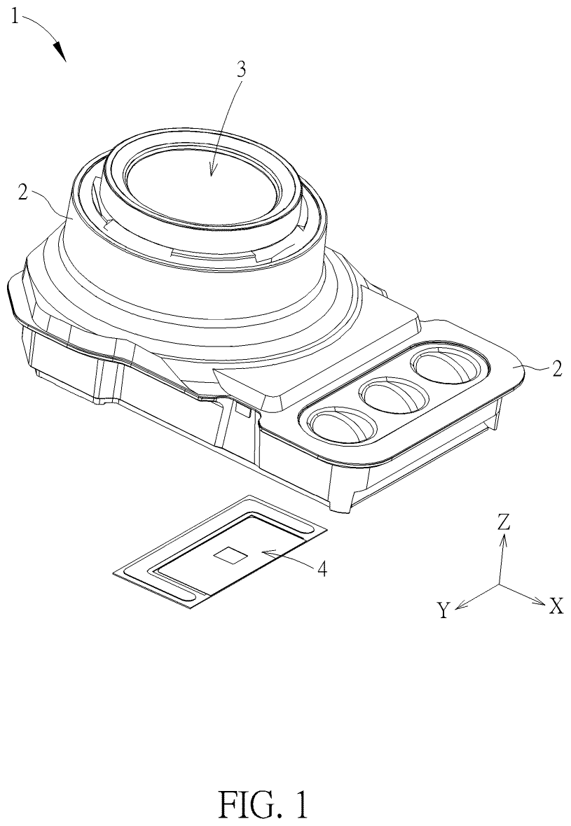

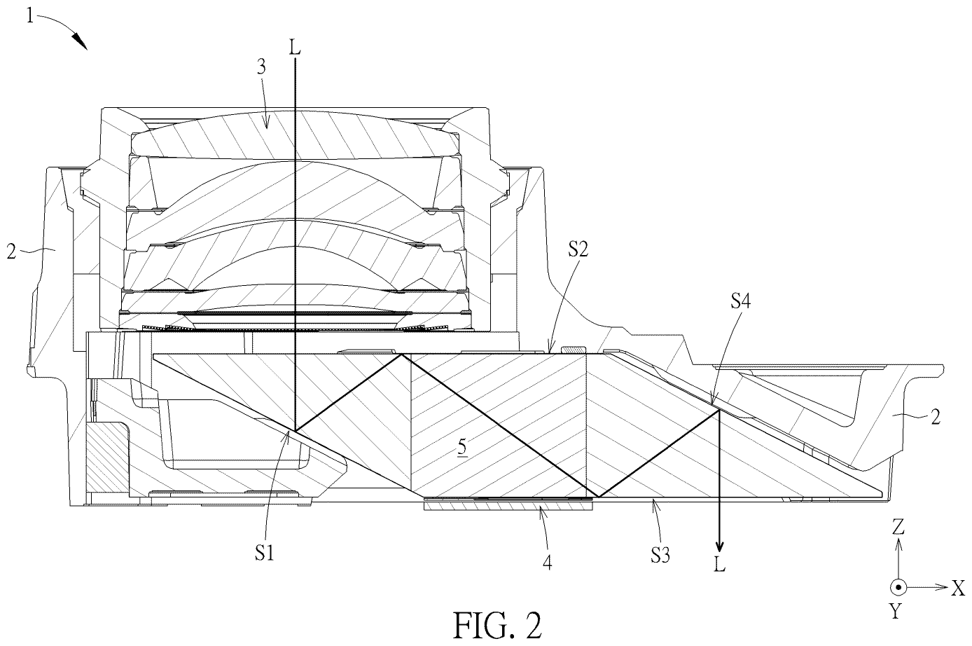

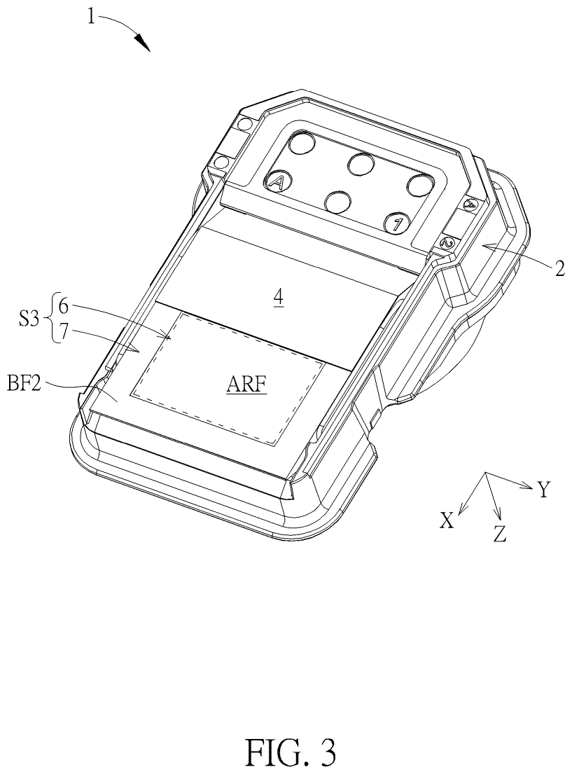

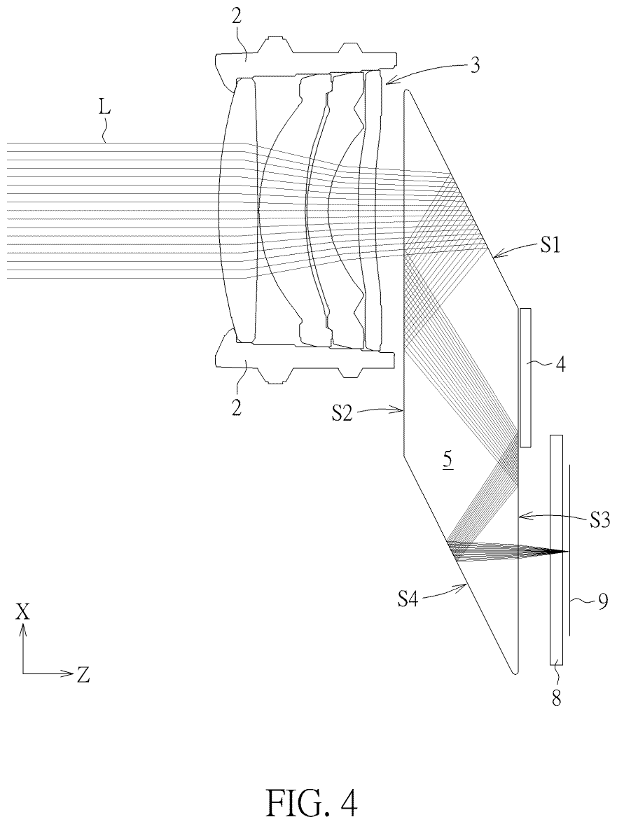

Please refer to FIG. 1, FIG. 2, FIG. 3 and FIG. 4. FIG. 1 shows a schematic diagram of the three-dimensional structure of an optical imaging lens module according to the present invention, FIG. 2 shows a schematic diagram of the cross-sectional structure of an optical imaging lens module according to the present invention, FIG. 3 shows a schematic diagram of the three-dimensional structure of an optical imaging lens module according to the present invention viewed from a bottom surface direction, and FIG. 4 shows a simulated schematic diagram of imaging ray passing through the optical imaging lens and light reflecting elements. The optical imaging lens module 1 of the present invention is, for example, a periscope lens module, which includes a barrel 2, an optical imaging lens 3 and a light reflecting element 5 located in the barrel 2, and a metal light collecting component 4 attached to one of the outer surfaces of the light reflecting element 5. In more detail, the material of the barrel 2 may include plastic or metal, but it is not limited to this. The barrel 2 is used to contain, support, fix and protect the optical imaging lens 3 and the light reflecting element 5. The optical imaging lens 3 and the light reflecting element 5 are arranged in the barrel 2, and the barrel 2 may also include elements such as fixing rings (not shown) for fixing the optical imaging lens 3 and the light reflecting element 5 in the barrel 2, which is not shown here for the sake of simplicity of the drawing.

As shown in FIG. 2, the optical imaging lens 3 includes a plurality of lens elements arranged along the optical axis direction (Z direction in FIG. 2). When the light L emitted by an object (not shown) enters the optical imaging lens 3 of the present invention, it will sequentially pass through the lens elements of the optical imaging lens 3 and the light reflecting element 5, and then focus on the image plane (not shown) to form a clear image. It is worth noting that the number of lens elements, lens surface shape and other parameters of the optical imaging lens 3 can be adjusted as required. Specifically, in FIG. 2, although the optical imaging lens 3 includes four lens elements, actually, in the concept of the present invention, the optical imaging lens 3 may include more or less lens elements, and the concave/convex surface shape, optical parameters, relative position configuration, etc. of each lens element can be adjusted as required. In other words, if it is satisfied that the light L can be focused on the image plane to form a clear image after passing through the optical imaging lens 3 and being reflected several times by the light reflecting element 5, the optical imaging lens 3 can be applied to the present invention and belongs to the scope of the present invention.

The light reflecting element 5 in the present invention is, for example, a prism, a mirror or other appropriate reflecting elements, and this embodiment will take the prism as an example. In the application of the periscope lens module, in order to meet the requirements of thinning and increase the focal length and telescopic magnification of the periscope lens module at the same time, a light reflecting element 5 is arranged in the barrel 2. When the light L passes through the optical imaging lens 3, it will enter the light reflecting element 5 and be reflected for many times, and the path of the light L will be prolonged. Since the telescopic magnification of the optical imaging lens is in direct proportion to the focal length, by setting up the light reflecting element 5 to extend the travel path of the light L, the focal length and telephoto magnification of the optical imaging lens module 1 can be increased without excessively increasing the thickness of the lens.

However, after the light reflecting element 5 is provided, although the focal length and telescopic magnification of the optical imaging lens module 1 are improved without excessively increasing the lens thickness, but the light L will be reflected in the light reflecting element 5 for many times. According to the experimental results of the applicant, it is found that when the light L is reflected in the light reflecting element 5 for many times, it is easy to generate high-brightness stray light and affect the imaging quality, such as torch stray light. Specifically, torch stray light is some diffuse reflection or scattered light generated by light L after being reflected by light reflecting element 5 such as prism. These lights do not propagate along the optical axis as expected, but scatter in all directions, and finally enter the image plane, forming a vague and unclear background light. Torch stray light has the disadvantages of reducing the contrast of imaging images, producing artifacts, and reducing the signal-to-noise ratio, so it is necessary to find ways to reduce the problems caused by the above high brightness stray light.

In order to solve the problem of high brightness stray light, in the first embodiment of the present invention, the optical imaging lens module 1 includes a metal light collecting component 4, wherein the metal light collecting component 4 is attached to one of the outer surfaces of the light reflecting element 5, and the metal light collecting component 4 has the effects of reducing stray light and improving imaging quality. It is worth noting that in FIG. 1, in order to clearly show the relative position between the barrel 2 and the metal light collecting component 4, the metal light collecting component 4 is drawn at a distance below the barrel 2, but in fact, the metal light collecting component 4 should be attached to one of the outer surfaces of the light reflecting element 5 as shown in FIG. 2. The detailed structure of the metal light collecting module 4 will be described in the following paragraphs.

As shown in FIG. 2, after the light L passes through the optical imaging lens 3 and enters the light reflecting element 5, the light L will be reflected by a plurality of reflecting surfaces of the light reflecting element 5 in sequence. As shown in FIG. 2 and FIG. 4, in order to clearly show the reflecting surfaces of the light reflecting element 5, a plurality of reflecting surfaces of the light reflecting element 5 are defined as a first reflecting surface S1, a second reflecting surface S2, a third reflecting surface S3 and a fourth reflecting surface S4 in sequence. The order in which the first reflecting surface S1, the second reflecting surface S2, the third reflecting surface S3 and the fourth reflecting surface S4 are defined above is the same as the order in which the light L is reflected by each reflecting surface when it enters the light reflecting element 5. That is, when the light L enters the light reflecting element 5, it will be reflected by the first reflecting surface S1, the second reflecting surface S2, the third reflecting surface S3 and the fourth reflecting surface S4 in sequence. In this embodiment, the second reflecting surface S2 and the third reflecting surface S3 may be parallel to each other, and the first reflecting surface S1 and the fourth reflecting surface S4 may be parallel to each other from the sectional view (FIG. 2 or FIG. 4), but the present invention is not limited to this. The light reflecting element 5 disclosed in FIG. 2 or FIG. 4 has a parallelogram profile in cross section, but the specific shape of the light reflecting element 5 in the present invention can be adjusted as required. For example, in other embodiments of the present invention, the light reflecting element 5 may include other shapes such as trapezoid, which is also within the scope of the present invention.

In addition, as shown in FIG. 2 or FIG. 4, the light L will penetrate into the light reflecting element (prism) 5 from the second reflecting surface S2, and then pass through the light reflecting element 5 from the third reflecting surface S3 after several reflections. In order to let the light L pass through the light reflecting element 5 smoothly, a light-transmitting region 6 and a non-light-transmitting region 7 (refer to FIG. 3 together) are arranged on the second reflecting surface S2 and the third reflecting surface S3 of the light reflecting element 5, wherein the main function of the light-transmitting region 6 is to allow the light L to pass through the light reflecting element 5, while the non-light-transmitting region 7 is to prevent the light L from being transmitted from an unexpected angle when it is reflected inside the light reflecting element 5. Therefore, a black film BF2 can be formed and covered on the surface of the opaque region 7, wherein the function of the black film BF2 is mainly to absorb redundant light and reduce stray light, and the material of the black film BF2 may include metal film, oxide film, carbon-based film, polymer film, etc., but the present invention is not limited to this. In addition, except for the second reflecting surface S2 and the third reflecting surface S3, the other reflecting surfaces of the light reflecting element 5 do not need to be penetrated by light, so they can be completely covered by the black film BF2, that is to say, these reflecting surfaces do not include light-transmitting regions.

FIG. 4 is a simulation diagram showing that a plurality of imaging rays (light L) parallel to the optical axis, and finally converge on the image plane 9 after passing through the optical imaging lens 3 and the light reflecting element 5. As can be seen from FIG. 4, the light L enters the light reflecting element 5 after passing through the optical imaging lens 3, and then is repeatedly reflected inside the light reflecting element 5, and finally passes through the third reflecting surface S3 of the light reflecting element 5 and is focused on the image plane 9, and a clear image is formed on the image plane 9. In some embodiments, a filter 8, such as an infrared cut-off filter, may be additionally arranged between the image plane 9 and the light reflecting element 5, which is used to prevent infrared rays in the imaging ray from being transmitted to the image plane 9 and affecting the imaging quality. However, the present invention is not limited to the necessity of forming the optical filter 8. In other words, in some embodiments of the present invention, the optical filter 8 may be omitted and not formed.

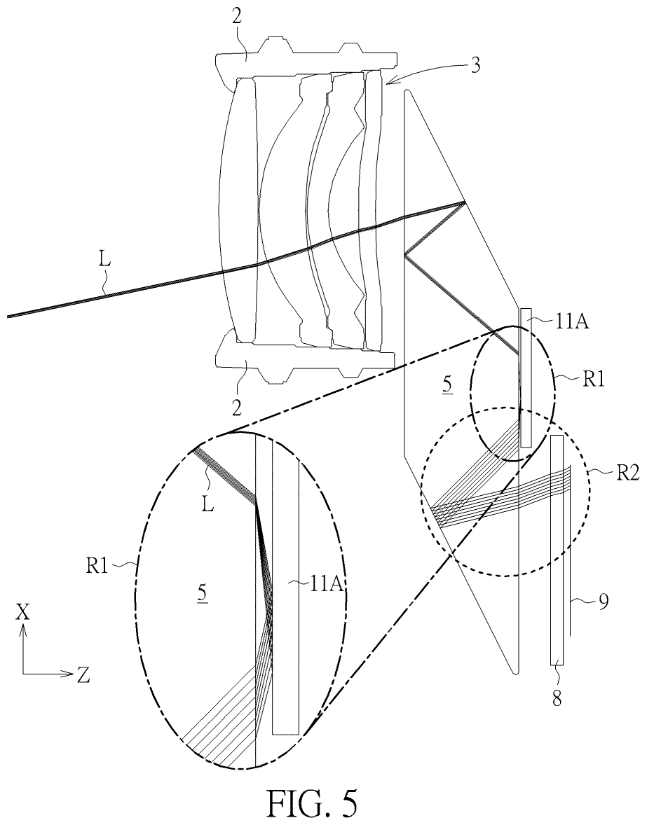

In addition, the position of the metal light collecting component 4 is also depicted in FIG. 4. As mentioned above, the metal light collecting component 4 is attached to the third reflecting surface S3 of the light reflecting element 5, which has the effect of absorbing stray light and improving the imaging quality. In order to more clearly highlight the efficacy of the metal light collecting component 4, the applicant has provided another embodiment, as shown in FIG. 5, which shows a simulation schematic diagram of imaging ray passing through an optical imaging lens and a light reflecting element in another embodiment of the present invention. The main difference between the embodiment of FIG. 5 and the embodiment of FIG. 4 is that the metal light collecting module 4 is replaced by a light shielding sheet 11A, which means that the optical imaging lens module of the embodiment of FIG. 5 does not include the metal light collecting module 4, but includes a light shielding sheet 11A. In addition, the other parameters of the optical imaging lens module, including the parameters of the optical imaging lens 3 and the light reflecting element 5, are the same as those of the embodiment shown in FIG. 4. As can be seen from FIG. 5, when the light L with non-optical design passes through the optical imaging lens 3 and enters the light-reflecting element 5, it may penetrate the surface of the light-reflecting element 5, enter the air gap between the light-reflecting element 5 and the light shielding sheet 11A, and form stray light at the same time, and then the stray light is reflected by the surface of the light shielding sheet 11A and re-enters the light-reflecting element 5 to generate high-brightness stray light (as shown in the enlarged area R1 and the area R2 circled in FIG. 5). In other words, the light is not reflected in the original expected direction, and these unexpected stray lights will affect the imaging quality. Among them, the light shielding sheet 11A is, for example, a black PI sheet structure, and its light collecting effect is not as good as the above-mentioned metal light collecting module 4, so the single-layer light shielding sheet 11A cannot effectively solve the above-mentioned stray light problem. Therefore, it can be known from the simulation results of FIGS. 4 and 5 again that the metal light collecting module 4 of the present invention does have the functions of reducing stray light and improving imaging quality compared with the embodiment using the single-layer light shielding sheet 11A. In the following paragraphs, the structure of the metal light collecting module 4 and the differences between the metal light collecting module 4 and the light shielding sheet 11A will be described in more detail.

In other embodiments of the present invention, in order to solve the problem of stray light generated in the above-mentioned FIG. 5, a light reflecting element with a light shielding structure may be directly manufactured by plastic injection molding to shield stray light. That is, when the light reflecting element (prism) 5 is formed, a light shielding structure such as a rough surface is directly formed on the surface of the light reflecting element 5, and the light shielding structure and the light reflecting element 5 are integrally formed. Although the above method can improve the problem of high brightness stray light, it will also extend to other problems, that is, the plastic injection-molded light reflecting element 5 is prone to bump damage in coating, assembly and other processes because of its low hardness. In addition, because the light reflecting unit 5 with light shielding structure has many grooves or acute angles, it is easy to cause appearance problems such as bubbles or shrinkage in the molding process, which affects the reflection of imaging ray.

Therefore, in the first embodiment of the present invention, the light shielding structure is not integrally formed on the surface of the light reflecting element, but the metal light collecting component 4 is attached to the surface of the light reflecting element 5, so that the manufacturing process of the metal light collecting component 4 is simpler, and the problems such as assembly or shrinkage as mentioned above are not easy to occur, and the influence of stray light can be obviously improved to improve the imaging quality.

In the following paragraphs, the structural features of the metal light collecting component will be described emphatically. It can be understood that the metal light collecting component described below can be attached to an outer surface of the light reflecting element and applied to the optical lens imaging module including the light reflecting element described above. In order to simplify the explanation, the following paragraphs will not repeat the features of the optical lens imaging module.

### Second Embodiment

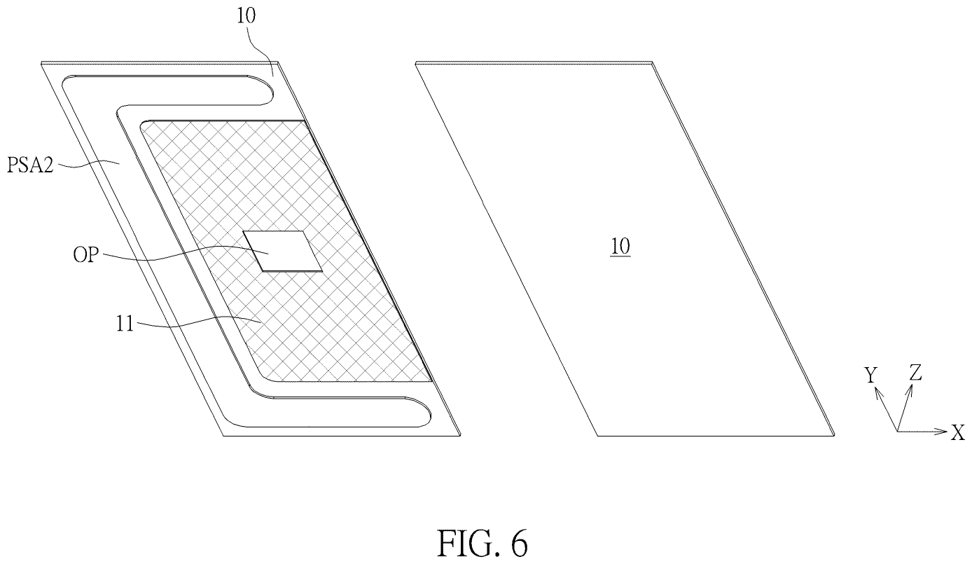

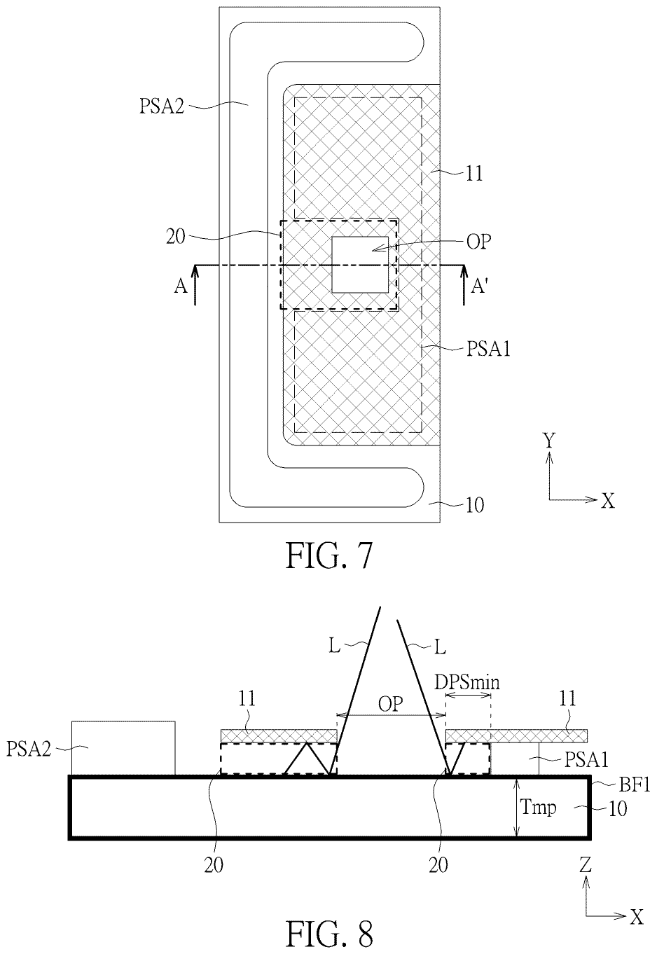

Please refer to FIGS. 6, 7 and 8. The left half of FIG. 6 shows a front perspective view of the metal light collecting module 4, the right half of FIG. 6 shows a back perspective view of the metal light collecting module 4, FIG. 7 shows a top view of the metal light collecting module according to an embodiment of the present invention, and FIG. 8 shows a cross-sectional view taken along the section line A-A′ of FIG. 7. As shown in FIG. 6, FIG. 7 and FIG. 8, the metal light collecting component 4 includes a metal sheet 10, and a light shielding sheet 11 is arranged on the front of the metal sheet 10, wherein the light shielding sheet 11 includes an opening OP. The metal sheet 10 here is made of stainless steel, for example, and its surface can be coated with a black film BF1 to increase light absorption and reduce reflection effect, such as an oxide film, a carbon-based film, a polymer film, etc. The present invention is not limited to this. The material of the light shielding sheet 11 is, for example, polyimide (PI), and the light shielding sheet 11 is also preferably black to enhance its light absorption effect, but the present invention is not limited to this. It is worth noting that the material of the light shielding sheet 11 here can be the same as that of the light shielding sheet 11A in FIG. 5, but the light shielding sheet 11A in FIG. 5 is only a single-layer PI structure, while the light shielding sheet 11 in this embodiment has an opening OP to allow light to pass through. The metal light collecting component 4 includes a metal sheet 10 and the light shielding sheet 11 with an opening, and the light collecting efficiency of the metal light collecting component 4 is better than that of the single-layer light shielding sheet 11A. The light shielding sheet 11 is bonded to the metal sheet 10 by a first pressure sensitive adhesive PSA1. It can be seen from the top view (FIG. 7) and the cross-sectional view (FIG. 8) that the space between the light shielding sheet 11 and the metal sheet 10 is not completely filled with the first pressure sensitive adhesive PSA1, but a space is left between the light shielding sheet 11 and the metal sheet 10, but this space is not filled with the first pressure sensitive adhesive PSA1, and this space is located around the opening OP when viewed from the top view. Here, this space is defined as the light collecting space 20. It can be seen more clearly from FIG. 8 that when the light (stray light generated from the prism) L enters the light collecting space 20 from the opening OP, the light L may be reflected in the light collecting space 20. However, since the lower metal sheet 10 and the upper light shielding sheet 11 are both preferably black or covered with a black film BF1, most of the light (stray light) L is absorbed or its direction is changed in the reflection process, thus significantly reducing stray light and preventing excessive stray light from affecting image quality.

As shown in FIG. 6 to FIG. 8, the metal sheet 10 further includes a second pressure sensitive adhesive PSA2, and the main function of the second pressure sensitive adhesive PSA2 is to attach the metal light collecting component 4 to the prism (the light reflecting element 5). The second pressure sensitive adhesive PSA2 in this embodiment can also be designed in a U-shape and surround the light shielding sheet 11. More specifically, the second pressure sensitive adhesive PSA2 can be located at the periphery of three sides of the light shielding sheet 11 without overlapping the light shielding sheet 11, so that the second pressure sensitive adhesive PSA2 will not affect the coverage of the light shielding sheet 11. In addition, as seen from FIG. 8, the thickness of the second pressure sensitive adhesive PSA2 is preferably greater than or equal to the sum of the thicknesses of the first pressure sensitive adhesive PSA1 and the light shielding sheet 11, that is, the top surface of the second pressure sensitive adhesive PSA2 is preferably higher than or equal to the top surface of the light shielding sheet 11. In this way, when the second pressure sensitive adhesive PSA2 is attached to the prism, the outer surface of the prism will not touch the light shielding sheet 11 and affect the structure of the light shielding sheet 11.

Here, Tmp is defined as the thickness of the metal sheet 10 within the contact region of the first pressure sensitive adhesive PSA1, that is, in this embodiment, Tmp is equal to the thickness of the metal sheet 10 in the Z-axis direction (as shown in FIG. 8), and Tm is a maximum thickness of the metal sheet 10 (in this embodiment, Tmp is equal to Tm). Tpsa1 is the thickness of the first pressure sensitive adhesive PSA1 along the Z axis, Tpsa2 is the thickness of the second pressure sensitive adhesive PSA2 along the Z axis, and Tsoma is the thickness of the light shielding sheet 11 along the Z axis. The following tables (Table 1 and Table 2) list the partial parameters of the metal sheet 10 and the light shielding sheet 11 according to different embodiments of the present invention (represented as embodiment A, embodiment B and embodiment C respectively) and the relationship between the parameters, as shown in Table 1 and Table 2 below:

TABLE 1

| | Metal sheet 10 | | | Light shielding sheet 11 | | |
|---|---|---|---|---|---|---|
| | Tpas2 | Mate- | Tm | Tpas1 | Mate- | Tsoma |
| | (μm) | rial | (μm) | (μm) | rial | (μm) |
| Embodiment | 60 | stainless | 40 | 40 | PI | 20 |
| A | | steel | | | | |
| Embodiment | 50 | stainless | 40 | 40 | PI | 16 |
| B | | steel | | | | |
| Embodiment | 60 | stainless | 40 | 40 | PI | 16 |
| C | | steel | | | | |

TABLE 2

| | | Tmp + Tpas1 + | (Tm + Tpas2)/(Tmp + |
|---|---|---|---|
| | Tm + Tpas2 | Tsoma | Tpas1 + Tsoma) |
| Embodiment | 100 | 100 | 1 |
| A | | | |
| Embodiment | 90 | 96 | 0.9375 |
| B | | | |
| Embodiment | 100 | 96 | 1.041666667 |
| C | | | |

### Third Embodiment

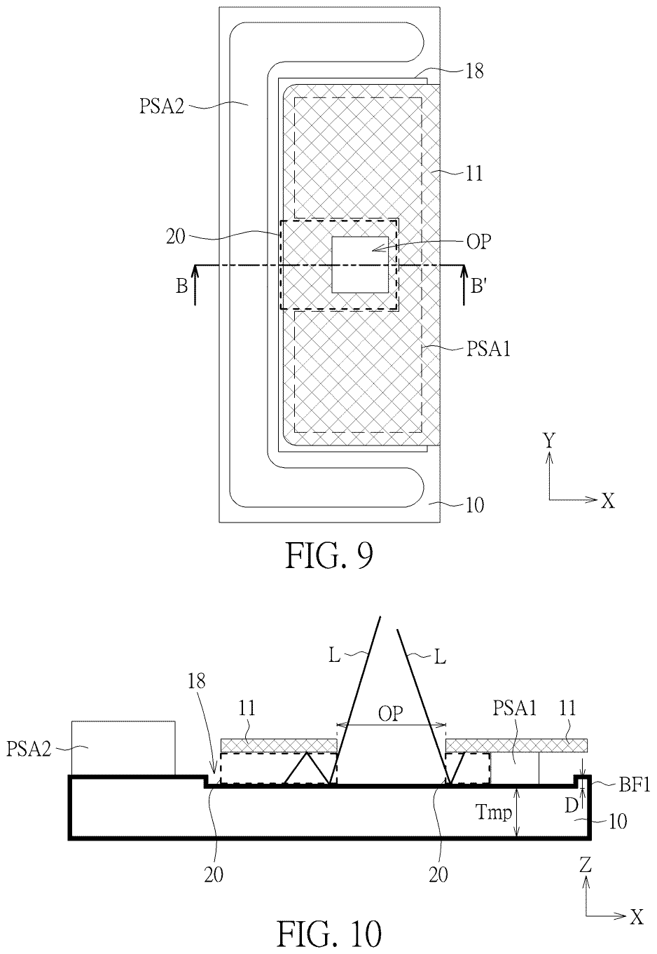

Please refer to FIG. 6, FIG. 9 and FIG. 10. FIG. 9 shows a top view of a metal light collecting module according to another embodiment of the present invention, and FIG. 10 shows a sectional view taken along section line B-B′ of FIG. 9. As shown in FIG. 6, FIG. 9 and FIG. 10, the metal light collecting module 4 also includes a metal sheet 10, and the front of the metal sheet 10 has a light shielding sheet 11, wherein the light shielding sheet 11 includes an opening OP. The light shielding sheet 11 is bonded to the metal sheet 10 by a first pressure sensitive adhesive PSA 1. The second pressure sensitive adhesive PSA2 is located on the metal sheet 10, and is designed to surround the light shielding sheet 11 in a U-shape. In addition, a light collecting space 20 is also defined, in which the light collecting space 20 is located between the light shielding sheet 11 and the metal sheet 10, the light collecting space 20 is not filled with the first pressure sensitive adhesive PSA1, and the light collecting space 20 is located around the opening OP as viewed from FIG. 9. Most of the above features are the same as the above-mentioned second embodiment, so the similarities are not repeated here.

The difference between this embodiment and the above embodiment is that the metal sheet 10 contains a groove 18, wherein the groove 18 can be formed by etching, and the groove 18 has a depth D, and the first pressure sensitive adhesive PSA1 is located in the groove 18. Since the groove 18 has a depth D, the top surface of the first pressure sensitive adhesive PSA1 and the top surface of the light shielding sheet 11 are also lowered. Therefore, the top surface of the first pressure sensitive adhesive PSA1 and the top surface of the light shielding sheet 11 in this embodiment will be lower than those of the first pressure sensitive adhesive PSA1 and the light shielding sheet 11 in the second embodiment. Specifically, the reduction in height is equal to the depth D.

It can be seen more clearly from FIG. 10 that when the light (stray light generated from the prism) L enters the light collecting space 20 from the opening OP, the light L will be reflected in the light collecting space 20. However, since both the lower metal sheet 10 and the upper light shielding sheet 11 may be black or contain a black film BF1, most of the light (stray light) L is absorbed or its direction is changed in the reflection process, thus significantly reducing stray light and preventing excessive stray light from affecting image quality. In addition, as shown in FIG. 10, the thickness of the second pressure sensitive adhesive PSA2 is preferably greater than or equal to the sum of the thicknesses of the first pressure sensitive adhesive PSA1 and the light shielding sheet 11 minus the depth D of the groove 18, that is, the top surface of the second pressure sensitive adhesive PSA2 is preferably higher than or equal to the top surface of the light shielding sheet 11. In this way, when the second pressure sensitive adhesive PSA2 is attached to the prism, the outer surface of the prism will not touch the light shielding sheet 11 and affect the structure of the light shielding sheet 11. As described above, due to the existence of the groove 18, the top surface of the first pressure sensitive adhesive PSA1 and the top surface of the light shielding sheet 11 are both lowered, so the thickness of the second pressure sensitive adhesive PSA2 can also be designed with a reduced thickness. In this way, the thickness of the whole metal light collecting module 4 can also be reduced. Except for the above features, the remaining features of this embodiment are the same as those of the above-mentioned second embodiment, and are not repeated here.

Here, Tmp is defined as the thickness of the metal sheet 10 within the contact region of the first pressure sensitive adhesive PSA1. Since the first pressure sensitive adhesive PSA1 is located in the groove 18 in this embodiment, Tmp is equal to the thickness of the metal sheet 10 at the first pressure sensitive adhesive PSA1, or equal to the thickness of the unetched metal sheet 10 minus the depth D of the groove 18 (as shown in FIG. 10), and Tm is the maximum thickness of the metal sheet 10 (in this embodiment, Tmp=Tm−D). Tpsa1 is the thickness of the first pressure sensitive adhesive PSA1 along the Z axis, Tpsa2 is the thickness of the second pressure sensitive adhesive PSA2 along the Z axis, and Tsoma is the thickness of the light shielding sheet 11 along the Z axis. The following tables (Table 3 and Table 4) list the partial parameters of the metal sheet 10 and the light shielding sheet 11 according to different embodiments of the present invention (represented as embodiment D, embodiment E and embodiment F respectively) and the relationship between the parameters, as shown in Table 3 and Table 4 below:

TABLE 3

| | Metal sheet 10 | | | | | | |
|---|---|---|---|---|---|---|---|
| | | | | Etching | Light shielding sheet 11 | | |
| | Tpas2 | Mate- | Tm | depth | Tpas 1 | Mate- | Tsoma |
| | (μm) | rial | (μm) | D (μm) | (μm) | rial | (μm) |
| Embodiment | 30 | stainless | 40 | 26 | 40 | PI | 16 |
| D | | steel | | | | | |
| Embodiment | 30 | stainless | 40 | 16 | 30 | PI | 16 |
| E | | steel | | | | | |
| Embodiment | 30 | stainless | 50 | 36 | 50 | PI | 16 |
| F | | steel | | | | | |

TABLE 4

| | | Tmp + Tpas1 + | (Tm + Tpas2)/(Tmp + |
|---|---|---|---|
| | Tm + Tpas2 | Tsoma | Tpas1 + Tsoma) |
| Embodiment | 70 | 70 | 1 |
| D | | | |
| Embodiment | 70 | 70 | 1 |
| E | | | |
| Embodiment | 80 | 80 | 1 |
| F | | | |

In the above embodiments, the parameters such as the size and position of the elements will affect the performance of the metal light collecting module 4. For example, as shown in FIG. 7, the first pressure sensitive adhesive PSA1 is designed to be similar to a “U” shape, in which a part of space is left around the opening OP as the range of the light collecting space 20, so the area of the light collecting space 20 is related to the coverage area of the first pressure sensitive adhesive PSA1. In addition, the thickness Tpsa1 of the first pressure sensitive adhesive PSA1 is also related to the height of the light collecting space 20. Therefore, various parameters such as the area of the light shielding sheet 11, the area of the opening OP, and the distance between the opening OP and the first pressure sensitive adhesive PSA1 will also affect the size of the light collecting space, light collecting efficiency, structural stability and other results of the metal light collecting module 4. Therefore, the following paragraphs will explore the optimal ratio relationships between various parameters. When the following condition is satisfied, corresponding advantages can be obtained, as detailed below.

1. The invention provides a metal light collecting component 4, which comprises a metal sheet 10 and a light shielding sheet 11 with an opening OP, wherein the light shielding sheet 11 is arranged on a surface of the metal sheet 10, and a light collecting space 20 is formed between the region near the opening OP of the light shielding sheet 11 and the metal sheet 10, so that stray light entering the light collecting space through the opening OP can be attenuated. Due to the pressure resistance of the metal sheet 10, it is difficult to deform, and the pressure resistance of the pressure sensitive adhesive is matched, so that the metal sheet 10 and the light shielding sheet 11 can form a stable light collecting space. Through the opening OP of the light shielding sheet 11 of the metal light collecting module 4, high-brightness stray light entering the light collecting space 20 through the opening OP can be attenuated, for example, torch stray light, or the high-brightness stray light entering the light collecting space 20 through the opening OP can change the direction of stray light through the reflection of the light collecting space 20, so that its high-brightness stray light will not reach the image sensor and affect the imaging quality.

2. The present invention also provides an optical lens imaging module 1 comprising the metal light collecting component 4, which comprises a barrel 2, an optical imaging lens 3 arranged in the barrel 2, and a light reflecting element (such as a prism) 5 arranged in the barrel 2, wherein the light reflecting element 5 comprises a first reflecting surface S1, a second reflecting surface S2, a third reflecting surface S3 and a fourth reflecting surface S4. And the metal light collecting component 4 is arranged on the outer surface of one of the first reflecting surface S1, the second reflecting surface S2, the third reflecting surface S3 and the fourth reflecting surface S4, wherein the metal light collecting component 4 comprises a metal sheet 10 and a light shielding sheet 11 with an opening OP, and the light shielding sheet 11 is arranged on one surface of the metal sheet 10, the region near the opening OP and between the light shielding sheet 11 and the metal sheet 10 form a light collecting space 20, so that light entering the light collecting space through the opening OP can be attenuated. In the present invention, the metal light collecting component 4 is attached to the third reflecting surface S3 by the first pressure sensitive adhesive PSA1, and the metal light collecting component 4 includes a metal sheet 10, so that the pressure resistance of the pressure sensitive adhesive can be matched with the pressure resistance of the metal sheet 10, thereby the air gap between the metal light collecting component 4 and the light reflecting element 5 and the reflection of stray light can be avoided. Through the opening OP of the light shielding plate 11 of the metal light collecting component 4, the non-imaging ray entering the opening OP can be absorbed in the light collecting space between the light shielding plate 11 and the metal plate 10, so as to avoid or reduce the probability of torch stray light generated by the non-imaging ray due to the light reflecting element.

3. In some embodiments of the present invention, the surface of the metal sheet 10 has the first black film BF1, which is beneficial to increase the light absorption rate of the metal sheet 10 to attenuate stray light entering the light collecting space 20.

4. In some embodiments of the present invention, the metal light collecting component 4 includes a first pressure sensitive adhesive PSA1, which is arranged between the metal sheet 10 and the light shielding sheet 11, where A is defined as an area of the light shielding sheet 11, B is defined as an area of the first pressure sensitive adhesive PSA1, and C is defined as an area of the opening OP, and the condition of A>B+C is satisfied. Due to the relationship of the above areas, it is beneficial to design the light collecting space 20 to collect stray light with high brightness.

5. In some embodiments of the present invention, the condition of A−(B+C)>4.40 mm² is more satisfied. When the above condition is satisfied, it is beneficial to design a larger light collecting space 20 to collect more high-brightness stray light.

6. In some embodiments of the present invention, the condition of 3.20≤DPSmin/Tpsa1≤12.00 is more satisfied, where DPSmin is the shortest distance from the opening to the first pressure sensitive adhesive (as shown in FIG. 8) and Tpsa1 is the thickness of the first pressure sensitive adhesive. When the above condition is satisfied, the shortest distance from the opening OP to the first pressure sensitive adhesive PSA1 is long enough, so that high-brightness stray light with enough angles can generate enough reflection, and it is easier to reduce the brightness of stray light or change the direction of stray light, and the thickness of the first pressure sensitive adhesive PSA1 is thick enough, so that the high-brightness stray light has enough space for reflection.

7. In some embodiments of the present invention, the conditions of 0.15 mm≤DPSmin≤0.40 mm and 0.03 mm≤Tpsa1≤0.05 mm are more satisfied, where DPSmin is the shortest distance from the opening to the first pressure sensitive adhesive, and Tpsa1 is the thickness of the first pressure sensitive adhesive. As mentioned above, this design is beneficial to reserve enough light collecting space 20 to attenuate high-brightness stray light, and by limiting the upper limit of DPSmin, the insufficient adhesion area of the first pressure sensitive adhesive PSA1 can be avoided.

8. In some embodiments of the present invention, an area where the light shielding sheet 11 is not adhered to the first pressure sensitive adhesive PSA1 is defined as D, and the condition of D>C is satisfied. It is worth noting that the area D here is equal to the area A of the light shielding sheet 11 minus the area B of the first pressure sensitive adhesive PSA1. When the above conditions are satisfied, it is beneficial to design the light collecting space 20 with sufficient area by the area relationship between the light shielding sheet 11 and the first pressure sensitive adhesive PSA1.

9. In some embodiments of the present invention, the metal sheet 10 includes an etched area (the groove 18), and an area of the etched area (the groove 18) is defined as E, and the condition of E>B is satisfied. When the above condition is satisfied, it is beneficial to reduce the thickness of the metal light collecting module 4 to be installed in the barrel 2, and also to reduce the situation that the second pressure sensitive adhesive PSA2 falls off due to shear force.

10. In some embodiments of the present invention, the condition of 0.07 mm≤Tmp+Tpsa1+Tsoma≤0.10 mm is more satisfied. As mentioned above, Tmp is defined as a thickness of the metal sheet 10 in the region where the metal sheet 10 contacts the first pressure-sensitive PSA1, Tpsa1 is a thickness of the first pressure-sensitive PSA1, and Tsoma is a thickness of the light shielding sheet 11. It is worth noting that when the metal sheet 10 does not contain the groove 18, Tmp is equal to the thickness of the metal sheet 10 in the Z direction, and when the metal sheet 10 contains the groove 18, Tmp is equal to the thickness of the metal sheet 10 in the Z direction minus the depth D of the groove 18. When the above condition is satisfied, it is beneficial to assemble the optical imaging lens module to reduce interference in a limited space.

11. In some embodiments of the present invention, a second pressure sensitive adhesive PSA2 is further provided on the metal sheet 10, and the condition of 0.93≤(Tm+Tpsa2)/(Tmp+Tpsa1+Tsoma)≤1.05 is satisfied, where Tpsa2 is the thickness of the second pressure sensitive adhesive, Tm is the maximum thickness of the metal sheet, Tmp is defined as a thickness of the metal sheet 10 in the region where the metal sheet 10 contacts the first pressure-sensitive PSA1, Tpsa1 is a thickness of the first pressure-sensitive PSA1, and Tsoma is a thickness of the light shielding sheet 11. When the above condition is satisfied, it is beneficial to design different etching depths of the grooves 18 and the thickness of each element by matching the pressure resistance of the pressure sensitive adhesive with the pressure resistance of the metal sheet 10, so as to prevent the formation of air gaps in the metal light collecting component 4, as air gaps allow non-imaging r to escape from the component, resulting in high-brightness stray light and degraded image quality.

12. In some embodiments of the present invention, the second pressure sensitive adhesive PSA2 is designed to surround the light shielding sheet 11 in a U-shape. As shown in FIG. 6, FIG. 7 and FIG. 9, it can be clearly seen that the second pressure sensitive adhesive PSA2 is designed to surround the three sides of the light shielding sheet 11 in a U-shape. This design is beneficial to increase the area of the second pressure sensitive adhesive PSA2 to strengthen the stability when adhering the prism, avoid the gap change caused by the warping of the metal sheet 10, and increase the design freedom of the opening OP of the light shielding sheet 11 to attenuate high-brightness stray light.

13. In some embodiments of the present invention, the metal light collecting component 4 is arranged on the outer surface of the third reflecting surface S3, which is beneficial to attenuate the high-brightness stray light of the third reflecting surface S3.

14. In some embodiments of the present invention, the light-reflecting element 5 has a light-transmitting region 6 and a non-light-transmitting region 7, the surface of the light-transmitting region 6 has a microstructure anti-reflection film ARF, and the surface of the non-light-transmitting region 7 has a second black film BF2, and the metal light collecting component 4 is adhered to the non-light-transmitting region 7 by a second pressure sensitive adhesive PSA2, and the light shielding sheet 11 is arranged on the light-transmitting region 6. When the above conditions are satisfied, it is beneficial to solve the high brightness stray light of non-imaging ray entering the light-transmitting region 6.

15. In some embodiments of the present invention, X is defined as a thickness of the second black film BF2, and Y is defined as a thickness of the microstructure anti-reflection film ARF, and the condition of X>Y is satisfied. When the above condition is satisfied, it is beneficial for the metal light collecting component 4 to adhere to the non-light-transmitting region 7, and at the same time, the light shielding sheet 11 will not contact with the microstructure anti-reflection film ARF, thus avoiding the pressure loss caused by the microstructure anti-reflection film ARF. X thickness ranges from 7 μm to 12 μm, and Y thickness ranges from 250 nm to 350 nm.

To sum up, the present invention is characterized in that in order to solve the problem that light reflecting elements (such as prisms) in an optical imaging lens module are easy to generate stray light, a metal light collecting component that can be adhered to the surface of the prism and an optical imaging lens module including the metal light collecting component are provided. Compared with the embodiment without metal light collecting components or the embodiment with only one layer of light shielding sheet, the embodiments of the invention can effectively reduce stray light and improve imaging quality. In addition, the metal light collecting component of the invention can be manufactured separately from the prism and has a relatively firm structure, and compared with the embodiment of directly forming an anti-reflection layer on the surface of the prism, the structure of the present invention has the advantages of simple assembly, high yield, stable structure and the like.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A metal light collecting component comprising:
a metal sheet; and
a light shielding sheet with an opening arranged on a surface of the metal sheet, wherein a light collecting space is defined, wherein the light collecting space is located in a region near the opening of the light shielding sheet, and located in a gap between the metal sheet and the light shielding sheet, wherein the light collecting space has the effect of attenuating stray light entering the light collecting space through the opening.

2. The metal light collecting component according to claim 1, wherein the surface of the metal sheet has a first black film.

3. The metal light collecting component according to claim 1, wherein the metal light collecting component further comprises a first pressure sensitive adhesive disposed between the metal sheet and the light shielding sheet, wherein A is defined as an area of the light shielding sheet, B is defined as an area of the first pressure sensitive adhesive, and C is defined as an area of the opening, and the condition of A>B+C is satisfied.

4. The metal light collecting module according to claim 3, wherein the condition of A−(B+C)>4.40 mm² is satisfied.

5. The metal light collecting module according to claim 3, wherein the condition of 3.20≤DPSmin/Tpsa1≤12.00 is satisfied, wherein DPSmin is a shortest distance from the opening to the first pressure sensitive adhesive, and Tpsa1 is a thickness of the first pressure sensitive adhesive.

6. The metal light collecting module according to claim 3, wherein the conditions of 0.15 mm≤DPSmin≤0.40 mm and 0.03 mm≤Tpsa1≤0.05 mm are satisfied, wherein DPSmin is a shortest distance from the opening to the first pressure sensitive adhesive, and Tpsa1 is a thickness of the first pressure sensitive adhesive.

7. The metal light collecting component according to claim 3, wherein an area where the light shielding sheet that is not adhered to the first pressure sensitive adhesive is defined as D, and the condition of D>C is satisfied.

8. The metal light collecting component according to claim 3, wherein the metal sheet comprises an etched area, and an area of the etched area is defined as e, and the condition of E>B is satisfied.

9. The metal light collecting component according to claim 3, further satisfying the condition of 0.07 mm≤Tmp+Tpsa1+Tsoma≤0.10 mm, wherein Tmp is defined as a thickness of the area where the metal sheet contacts the first pressure sensitive adhesive, Tpsa1 is a thickness of the first pressure sensitive adhesive, and Tsoma is a thickness of the light shielding sheet.

10. The metal light collecting component according to claim 3, further comprising a second pressure sensitive adhesive disposed on the metal sheet, and satisfying the condition of 0.93≤(Tm+Tpsa2)/(Tmp+Tpsa1+Tsoma)≤1.05, wherein Tpsa2 is a thickness of the second pressure sensitive adhesive, Tm is a maximum thickness of the metal sheet, Tmp is defined as a thickness of the area where the metal sheet contacts the first pressure sensitive adhesive, Tpsa1 is a thickness of the first pressure sensitive adhesive, and Tsoma is a thickness of the light shielding sheet.

11. The metal light collecting component according to claim 10, wherein the second pressure sensitive adhesive is designed in a U shape and surrounds the light shielding sheet.

12. An optical lens imaging module, comprising:
a barrel;
an optical imaging lens arranged in the barrel;
a light reflecting element arranged in the barrel, and the light reflecting element comprises a first reflecting surface, a second reflecting surface, a third reflecting surface and a fourth reflecting surface;
a metal light collecting component arranged on an outer surface of one of the first reflecting surface, the second reflecting surface, the third reflecting surface and the fourth reflecting surface, wherein the metal light collecting component comprises a metal sheet, and a light shielding sheet with an opening arranged on a surface of the metal sheet, wherein a light collecting space is defined, wherein the light collecting space is located in a region near the opening of the light shielding sheet, and located in a gap between the metal sheet and the light shielding sheet, wherein the light collecting space has the effect of attenuating stray light entering the light collecting space through the opening.

13. The optical lens imaging module according to claim 12, wherein the metal light collecting component is arranged on an outer surface of the third reflecting surface of the light reflecting element.

14. The optical lens imaging module according to claim 12, wherein the light reflecting element has a light-transmitting region and a non-light-transmitting region, the surface of the light-transmitting region has a microstructure anti-reflection film, and the surface of the non-light-transmitting region has a second black film, and the metal light collecting component is adhered to the non-light-transmitting region by a second pressure sensitive adhesive, and the light shielding sheet is arranged on the light-transmitting region.

15. The optical lens imaging module according to claim 14, wherein X is defined as a thickness of the second black film, Y is defined as a thickness of the microstructure anti-reflection film, and the condition of X>Y is satisfied.
